(19) United States
(12) Patent Application Publication
(10) Pub. No.: US 2023/0124585 A1
(43) Pub. Date: Apr. 20, 2023

(54) INDUCTOR AND ELECTRONIC DEVICE INCLUDING THE SAME

(71) Applicant: LG DISPLAY CO., LTD., Seoul (KR)

(72) Inventor: JaeKwon CHAE, Chilgok-gun (KR)

(73) Assignee: LG DISPLAY CO., LTD., Seoul (KR)

(21) Appl. No.: 17/872,322

(22) Filed: Jul. 25, 2022

(30) Foreign Application Priority Data
Oct. 19, 2021 (KR) 10-2021-0139729

(51) Int. Cl. H01F 27/38; H01F 1/20; H01F 27/28; H01F 27/40

(52) U.S. Cl. CPC H01F 27/38; H01F 1/20; H01F 27/2823; H01F 27/40

(57) ABSTRACT

Embodiments of the present disclosure relate to an inductor and an electronic device including the same. An inductor, according to one embodiment of the disclosure, can include a magnetic body, a coil located in the magnetic body, a first electrode located on a first portion of the magnetic body and electrically connected to one end of the coil, a second electrode located on a second portion of the magnetic body and electrically connected to another end of the coil, a radiation pattern located on a first surface of the magnetic body, and a third electrode located on a third portion of the magnetic body and electrically connected to the radiation pattern.

### CROSS-REFERENCE TO RELATED APPLICATION

This application claims priority to Korean Patent Application No. 10-2021-0139729, filed in the Republic of Korea on Oct. 19, 2021, the entire contents of which are hereby expressly incorporated by reference into the present application.

### BACKGROUND OF THE DISCLOSURE

### Field

Embodiments of the present disclosure relate to an inductor capable of improving an effect of electromagnetic interference, and an electronic device including the inductor.

### Discussion of the Related Art

As the information society develops, demand for an electronic device in which a display panel for displaying an image is mounted is increasing in various forms.

In this case, various display panels such as a liquid crystal display (LCD) panel, an organic light emitting display (OLED) panel, a quantum dot light emitting display (QLED) panel, and the like are used as display panels mounted in an electronic device.

Such a display panel can be employed in an electronic device such as a smart phone or a tablet PC, and the electronic device such as the smart phone or the tablet PC can use an antenna to communicate with other electronic devices.

In this case, the electronic device including the antenna can have a limitation in that electromagnetic interference between the antenna and an inner printed circuit board may increases in a specific frequency band.

Since such electromagnetic interference can impair the quality of an image displayed on the display panel or reduce communication quality, various methods capable of reducing the electromagnetic interference are being studied.

### SUMMARY OF THE DISCLOSURE

Accordingly, the inventor of the present specification has invented an inductor capable of reducing electromagnetic interference by combining a radiation pattern, and an electronic device including the same.

One or more embodiments of the present disclosure are directed to providing an inductor capable of radiating a phase-inverted signal that can reduce electromagnetic interference while reducing a spatial area by combining a radiation pattern for generating a phase-inverted signal capable of offsetting an electromagnetic interference signal on an outer side, and an electronic device including the same.

Further, one or more embodiments of the present disclosure are directed to providing an inductor capable of effectively reducing electromagnetic interference by forming a radiation pattern in a structure surrounding an outer side, and an electronic device including the same.

In addition, one or more embodiments of the present disclosure are directed to providing an inductor capable of effectively radiating a phase-inverted signal that can offset electromagnetic interference by combining an inverting circuit, and an electronic device including the same.

In addition, one or more embodiments of the present disclosure are directed to providing an inductor usable in various structures by controlling an operation of an inverting circuit according to an input signal, and an electronic device including the same.

According to an aspect of the present disclosure, there is provided an inductor including a magnetic body, a coil located in the magnetic body, a first electrode located on a first portion of the magnetic body and electrically connected to one end of the coil, a second electrode located on a second portion of the magnetic body and electrically connected to another end of the coil, a radiation pattern located on a first surface of the magnetic body, and a third electrode located on a third portion of the magnetic body and electrically connected to the radiation pattern.

According to another aspect of the present disclosure, there is provided an electronic device including an inductor in which a radiation pattern is formed on a surface of a magnetic body, a printed circuit board on which the inductor is disposed, and an inverting circuit formed on the printed circuit board. The inverting circuit is configured to invert a phase of an input signal applied to the inductor to generate an inverted input signal, and configured to supply the inverted input signal to the radiation pattern of the inductor.

According to one or more embodiments of the present disclosure, an inductor capable of reducing electromagnetic interference by combining a radiation pattern, and an electronic device including the same can be provided.

Further, according to one or more embodiments of the present disclosure, an inductor capable of radiating a phase-inverted signal that can reduce electromagnetic interference while reducing a spatial area by combining a radiation pattern capable of generating a phase-inverted signal for offsetting an electromagnetic interference signal on an outer side, and an electronic device including the same can be provided.

In addition, according to one or more embodiments of the present disclosure, an inductor capable of reducing electromagnetic interference by forming a radiation pattern in a structure surrounding an outer side, and an electronic device including the same can be provided.

In addition, according to one or more embodiments of the present disclosure, an inductor capable of effectively radiating a phase-inverted signal that can offset electromagnetic interference by combining an inverting circuit, and an electronic device including the same can be provided.

In addition, according to one or more embodiments of the present disclosure, an inductor usable in various structures by controlling an operation of an inverting circuit according to an input signal, and an electronic device including the same can be provided.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a perspective view illustrating an inductor according to one of the embodiments of the present disclosure;

FIG. 2 is a plan view illustrating a case in which the inductor according to one of the embodiments of the present disclosure is manufactured by a pattern coating method;

FIG. 3 is a perspective view illustrating a case in which the inductor according to one of the embodiments of the present disclosure is manufactured by a resin molding method;

FIG. 4 is a view illustrating an example in which the inductor according to one of the embodiments of the present disclosure is disposed on a printed circuit board of an electronic device;

FIG. 5 is a view illustrating an electromagnetic interference signal according to an input signal and a radiation signal according to a radiation pattern in the inductor according to one of the embodiments of the present disclosure as examples;

FIG. 6 is a signal waveform diagram illustrating an electromagnetic interference offset effect when the inductor according to one of the embodiments of the present disclosure is used in the electronic device;

FIG. 7 is a perspective view illustrating a case in which an extending portion extending from the radiation pattern and connected to a third electrode is configured to surround another outer side of the inductor in the inductor according to one of the embodiments of the present disclosure;

FIG. 8 is a signal waveform diagram in which a phase-inverted signal radiated when the extending portion extending from the radiation pattern and connected to the third electrode is a straight line and a phase-inverted signal radiated when the extending portion is configured to surround another outer side of the inductor are compared in the inductor according to one of the embodiments of the present disclosure;

FIGS. 9 and 10 are perspective views illustrating a case in which an inverting circuit is disposed in the inductor according to one of the embodiments of the present disclosure;

FIG. 11 is a circuit diagram illustrating a case in which the inverting circuit for generating an inverted input signal is included in the inductor according to one of the embodiments of the present disclosure;

FIG. 12 is a circuit diagram illustrating an example in which the inverting circuit and a control circuit are located in the inductor according to one of the embodiments of the present disclosure; and

FIG. 13 is a diagram illustrating operations of first to fourth electrodes according to a case in which a non-inverted input signal and an inverted input signal are input to the third electrode in the inductor according to one of the embodiments of the present disclosure.

### DETAILED DESCRIPTION OF THE EMBODIMENTS

Hereinafter, embodiments of the present disclosure will be described in detail with reference to exemplary drawings. In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present invention, detailed descriptions of well-known functions and components incorporated herein will be omitted when it is determined that the description can make the subject matter in some embodiments of the present invention rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” can be used herein to describe elements of the present invention. Each of these terms is not used to define the essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element can be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms can be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to the accompanying drawings. All components of each inductor and each electronic device including the same according to all embodiments of the present disclosure are operatively coupled and configured.

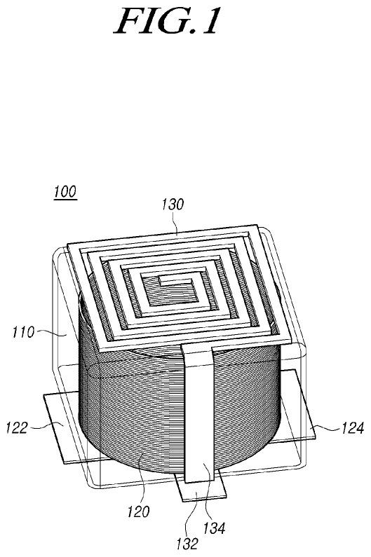

FIG. 1 is a perspective view illustrating an inductor according to one of the embodiments of the present disclosure.

Referring to FIG. 1, an inductor 100 according to one or more embodiments of the present disclosure includes a magnetic body 110, a coil 120 buried in the magnetic body 110, and a radiation pattern 130 formed at an outer side of the magnetic body 110.

One end of the coil 120 is electrically connected to a first electrode 122 formed on a first portion of the magnetic body 110, and the other end of the coil 120 is electrically connected to a second electrode 124 formed on a second portion of the magnetic body 110.

The first electrode 122 can be an electrode to which an input signal is applied, and the second electrode 124 can be an electrode to which an output signal is transmitted.

The radiation pattern 130 can be formed on an upper surface of the magnetic body 110, and the radiation pattern 130 can be electrically connected to a third electrode 132 formed on a third portion of the magnetic body 110 through an extending portion 134 extending in a straight line along the outer side of the magnetic body 110.

The third electrode 132 can be an electrode to which a signal having a phase opposite to that of the input signal applied to the first electrode 122 of the inductor 100 is applied.

Here, although an example in which the first electrode 122 and the second electrode 124 connected to the coil 120, and the third electrode 132 connected to the radiation pattern 130 are located on the same plane is shown, the first electrode 122, the second electrode 124, and the third electrode 132 can be located on different planes, and positions and directions thereof can vary according to a structure of the inductor 100.

The magnetic body 110 can have a three-dimensional shape such as a cylindrical shape, a prismatic shape, or the like, and the cylindrical shape is shown here as an example.

The magnetic body 110 can include powder of a metal alloy having soft magnetic properties, and can include pure iron, silicon steel sheet magnetic powder, amorphous magnetic powder, permalloy magnetic powder, high flux (HF) magnetic powder, sendust magnetic powder, ferrite magnetic powder, and the like.

For example, the magnetic body 110 can include at least one selected from the group consisting of Fe—Si—B-based magnetic powder, Fe—Ni-based magnetic powder, Fe—Si-based magnetic powder, Fe—Si—Al-based magnetic powder, Fe—Ni—Mo-based magnetic powder, Fe—B—Si—Nb—Cu-based magnetic powder, Fe—Si—Cr—Al-based magnetic powder, and Fe—(Si—P—)C—B-based magnetic powder.

Alternatively, the magnetic body 110 can include a plurality of stacked magnetic sheets. When the magnetic body 110 is formed of magnetic sheets, since the magnetic powder is uniformly distributed in the magnetic sheet, the inductor 100 having uniform performance can be acquired.

In this case, the magnetic sheet can include powder of a metal alloy having soft magnetic properties, and can include pure iron, silicon steel sheet magnetic powder, amorphous magnetic powder, permalloy magnetic powder, high flux (HF) magnetic powder, sendust magnetic powder, ferrite magnetic powder, and the like.

For example, the magnetic sheet can include a polymer binder formed of at least one selected from the group consisting of Fe—Si—B-based magnetic powder, Fe—Ni-based magnetic powder, Fe—Si-based magnetic powder, Fe—Si—Al-based magnetic powder, Fe—Ni—Mo-based magnetic powder, Fe—B—Si—Nb—Cu-based magnetic powder, Fe—Si—Cr—Al-based magnetic powder, and Fe—(Si—P—)C—B-based magnetic powder, and a resin.

The coil 120 can include a winding region to be wound and regions extending from the winding region and electrically connected to the first electrode 122 and the second electrode 124.

In this case, the regions extending from the winding region of the coil 120 can be connected to the first electrode 122 and the second electrode 124 in a state of being buried in the magnetic body 110.

The radiation pattern 130 can receive an inverted input signal having a phase inverted from that of the input signal applied to the inductor 100 to generate a phase-inverted signal which offsets electromagnetic interference formed around the inductor 100.

Accordingly, a signal having a phase opposite to that of the input signal applied to the first electrode 122 can be applied to the third electrode 132 connected to the radiation pattern 130 through the extending portion 134.

The radiation pattern 130 can have a circular or quadrangular spiral structure, and can be integrally formed on an outer surface of the magnetic body 110.

In this case, the radiation pattern 130 can be formed to have an area smaller than a cross-sectional area of the outer surface of the magnetic body 110 to be located in the outer surface of the magnetic body 110 on which the radiation pattern 130 is located.

For example, when the radiation pattern 130 is located on an upper surface of the magnetic body 110, the area of the radiation pattern 130 is formed in a size that does not deviate from an upper area of the magnetic body 110, and thus the radiation pattern 130 can be disposed within the upper area.

Like the above, when the radiation pattern 130 to which a signal having a phase opposite to that of the input signal is applied is integrally formed with the inductor 100, the electromagnetic interference generated by the inductor 100 can be effectively offset while minimizing the size of the inductor 100.

The inductor 100 of the present disclosure can be manufactured by a pattern coating method of forming the radiation pattern 130 after applying a paste on the outer side of the magnetic body 110, and a resin molding method of forming the magnetic body 110 so that the coil 120 and the radiation pattern 130 are integrated using a poly binder formed of magnetic powder and a resin in a state in which the radiation pattern 130 is disposed at an outer side of the coil 120.

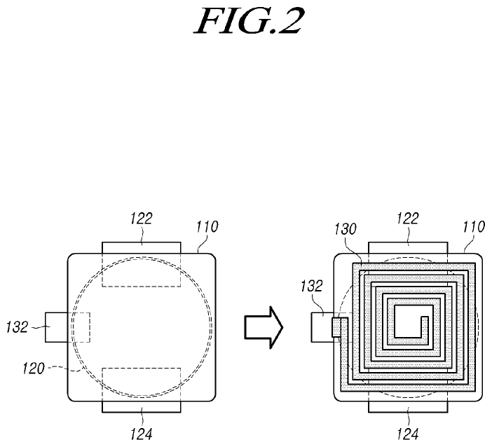

FIG. 2 is a plan view illustrating a case in which the inductor according to one of the embodiments of the present disclosure is manufactured by a pattern coating method.

Referring to FIG. 2, in the inductor 100 according to one or more embodiments of the present disclosure, the magnetic body 110 can be formed so that the coil 120 formed in a circular spiral structure is sealed.

The magnetic body 110 can have a three-dimensional shape such as a cylindrical shape, a prismatic shape, or the like, and can include powder of a metal alloy having soft magnetic properties.

For example, the magnetic body 110 can include pure iron, silicon steel sheet magnetic powder, amorphous magnetic powder, permalloy magnetic powder, high flux (HF) magnetic powder, sendust magnetic powder, ferrite magnetic powder, and the like. Alternatively, the magnetic body 110 can include a plurality of stacked magnetic sheets.

The first electrode 122 and the second electrode 124 can be formed in a state of extending from the winding region of the coil 120 and being buried in the magnetic body 110, the input signal can be applied to the first electrode 122, and the output signal can be transmitted from the second electrode 124.

In a state in which the magnetic body 110 which seals the coil 120 is formed, a paste can be applied to the outer side of the magnetic body 110 and cured. The paste can be formed by selecting one or more from nickel (Ni), tin (Sn), silver (Ag), copper (Cu), gold (Au), palladium (Pd), and the like.

In a state in which the paste is applied to the outer side of the magnetic body 110, the radiation pattern 130 is coated on the upper surface of the magnetic body 110. In this case, the radiation pattern 130 formed on the upper surface of the magnetic body 110 can extend along a side surface of the magnetic body 110 to be electrically connected to the third electrode 132.

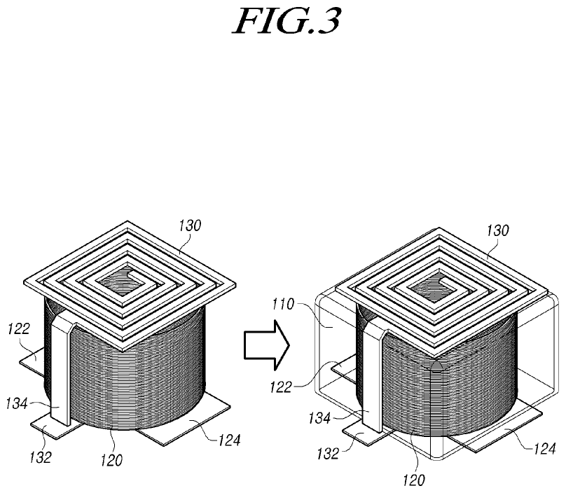

FIG. 3 is a perspective view illustrating a case in which the inductor according to one of the embodiments of the present disclosure is manufactured by a resin molding method.

Referring to FIG. 3, first, in the inductor 100 according to one or more embodiments of the present disclosure, the first electrode 122 and the second electrode 124 are electrically connected to one side and the other side of the coil 120 having a circular spiral structure, respectively.

Next, the radiation pattern 130 is disposed on the coil 120 to be spaced apart from the coil 120 at a predetermined interval, and one side of the radiation pattern 130 is extended to be electrically connected to the third electrode 132.

In this state, the magnetic body 110 can be formed so that the coil 120 having a circular spiral structure can be sealed and the radiation pattern 130 can be integrally fixed thereto.

The magnetic body 110 can be formed by mixing magnetic metal powder and an epoxy resin, and applying and curing the pulverulent material.

In this case, the strength of the magnetic body 110 can be increased by heat-treating the mixture of the magnetic metal powder and the epoxy resin.

For example, the magnetic body 110 can include pure iron, silicon steel sheet magnetic powder, amorphous magnetic powder, permalloy magnetic powder, high flux (HF) magnetic powder, sendust magnetic powder, ferrite magnetic powder, and the like.

Like the above, since the radiation pattern 130 to which the signal having a phase opposite to that of the input signal is applied is integrally formed at the outer side of the inductor 100, the electromagnetic interference generated by the inductor 100 can be offset while minimizing the size of the inductor 100.

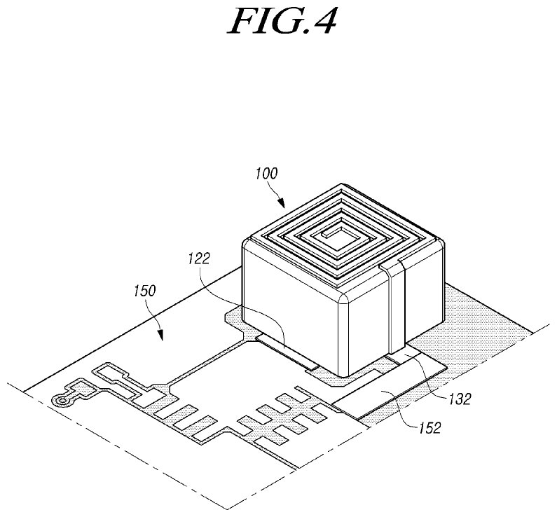

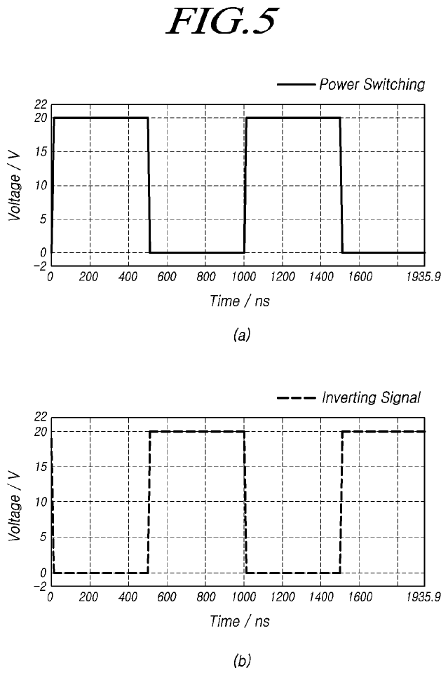

FIG. 4 is a view illustrating an example in which the inductor according to one of the embodiments of the present disclosure is disposed on a printed circuit board of an electronic device, and FIG. 5 is a view illustrating an electromagnetic interference signal according to an input signal and a radiation signal according to a radiation pattern of the inductor as examples.

First, referring to FIG. 4, the inductor 100 according to one or more embodiments of the present disclosure can be located on one surface of a printed circuit board 150 on which circuit elements for operation of the electronic device are formed.

The electronic device can include a housing capable of protecting circuit elements included in the printed circuit board 150. Accordingly, the printed circuit board 150, a display panel, and a battery can be accommodated between an upper housing and a lower housing of the electronic device, and the housing can protect these components from an external impact. The housing of the electronic device can be formed of, for example, tempered glass, plastic, metal, and/or the like.

Specifically, the electronic device can include an antenna capable of transmitting or receiving radio signals of various frequencies, wherein at least a portion of the housing can be used as a radiator of the antenna, and the antenna can be disposed in the housing located at an upper portion or a lower portion of the electronic device in a film type or patch type.

Various electronic components, elements, printed circuits, or the like of the electronic device can be mounted on the printed circuit board 150. For example, the printed circuit board 150 can include a wireless communication circuit including a communication processor, an application processor, a memory, and the like.

The inductor 100 coupled to the printed circuit board 150 not only receives an input signal through the first electrode 122, but also receives an inverted input signal inverted from the input signal through an inverting circuit 152 located on the printed circuit board 150 through the third electrode 132.

Accordingly, as shown in FIG. 5, even when electromagnetic interference is generated by the input signal applied to the inductor 100 through the first electrode 122 (see (a) of FIG. 5), since a phase-inverted signal capable of offsetting the electromagnetic interference is radiated by the radiation pattern 130 formed in an integrated structure at the outer side of the magnetic body 110 (see (b) of FIG. 5), electromagnetic interference generated by the electronic device can be reduced.

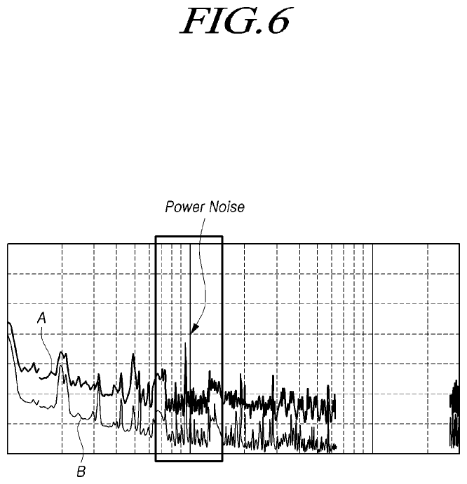

FIG. 6 is a signal waveform diagram illustrating an electromagnetic interference offset effect when the inductor according to one of the embodiments of the present disclosure is used in the electronic device.

Referring to FIG. 6, in the inductor 100 according to one of the embodiments of the present disclosure, the radiation pattern 130 is formed in the integrated structure at the outer side of the magnetic body 110, and thus it is possible to effectively offset the electromagnetic interference generated by the inductor 100.

For example, electronic devices mounted in a vehicle including a display panel receive power through a 12V battery power source, and include a voltage boosting device and a voltage dropping device for operation of the electronic device. Generally, in the case of the display panel, since a driving voltage of 3.3V or 20V can be used, an operation of dropping or boosting a voltage of the 12V battery power source is frequently performed.

In this case, the electronic device can be operated by a frequency signal of a certain frequency band, for example, 500 kHz to 1.8 MHz, and the coil 120 located in the inductor 100 generates a strong electromagnetic signal in a process of repeating charging and discharging, and accordingly, the electromagnetic interference for the electronic device increases.

In this situation, when the inductor 100 formed with the radiation pattern 130 in the integrated structure at the outer side of the magnetic body 110 is used, a phase-inverted signal having a higher level can be radiated compared to a case that uses an inductor from which a radiation pattern is separated in a limited region.

Specifically, when the radiation pattern 130 is formed in the integrated structure at the outer side of the magnetic body 110, since the phase-inverted signal having a phase opposite to that of the electromagnetic interference signal can be generated at a position closest to a source (first electrode 122) where electromagnetic interference is generated, electromagnetic interference in a radio frequency band can be effectively improved.

Here, in a specific frequency band in which the electronic device operates, the magnitude of electromagnetic interference A generated by a conventional inductor and the magnitude of electromagnetic interference B generated by the inductor 100 according to one or more embodiments of the present disclosure are indicated.

Meanwhile, in the inductor 100 of the present disclosure, since an extending portion extending from the radiation pattern 130 and connected to the third electrode 132 is configured to surround another outer side of the inductor 100, a radiation level of the phase-inverted signal for offsetting the electromagnetic interference signal can be increased.

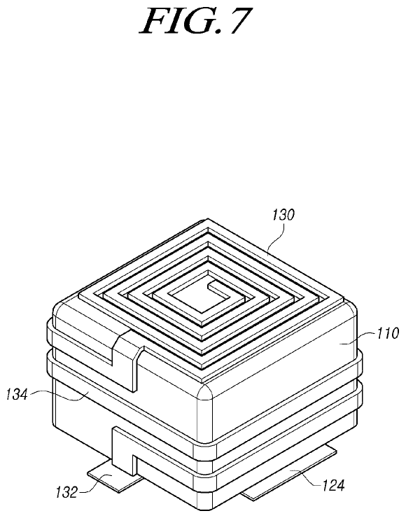

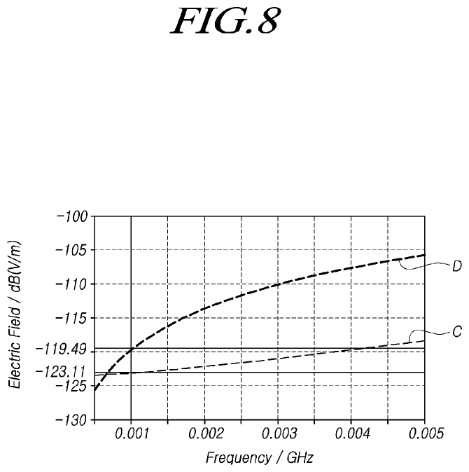

FIG. 7 is a perspective view illustrating a case in which the extending portion extending from the radiation pattern and connected to the third electrode is configured to surround another outer side of the inductor in the inductor according to one of the embodiments of the present disclosure, and FIG. 8 is a signal waveform diagram in which a phase-inverted signal radiated when the extending portion extending from the radiation pattern and connected to the third electrode is a straight line and a phase-inverted signal radiated when the extending portion is configured to surround another outer side of the inductor are compared.

Referring to FIG. 7, an inductor 100 according to one of the embodiments of the present disclosure includes a magnetic body 110, a coil buried in the magnetic body 110, and a radiation pattern 130 formed at an outer side of the magnetic body 110.

One side of the coil 120 is electrically connected to a first electrode 122 formed at one lower side of the magnetic body 110, and the other side of the coil 120 is electrically connected to a second electrode 124 formed at the other lower side of the magnetic body 110.

The first electrode 122 can be an electrode to which an input signal is applied, and the second electrode 124 can be an electrode to which the output signal is transmitted.

The radiation pattern 130 can be formed on an upper surface of the magnetic body 110, and a third electrode 132 electrically connected to the radiation pattern 130 can be formed on the same surface as the first electrode 122 and the second electrode 124.

In this case, the radiation pattern 130 and the third electrode 132 can be connected to each other by an extending portion 134 extending from the radiation pattern 130, and the extending portion 134 can be formed in a spiral shape along a second surface (for example, a side surface) other than a first surface (for example, an upper surface) on which the radiation pattern 130 is located in the magnetic body 110.

Like the above, when a length of the extending portion 134 formed between the radiation pattern 130 and the third electrode 132 increases, since a level of a phase-inverted signal radiated through the radiation pattern 130 increases, an offset effect of the electromagnetic interference can be further increased.

Referring to FIG. 8, in the inductor 100 according to one of the embodiments of the present disclosure, it can be seen that the level of the radiated phase-inverted signal further increases in a case (D) in which the extending portion 134 extending from the radiation pattern 130 and connected to the third electrode 132 is formed in a spiral structure surrounding a surface (for example, a side surface) other than a surface (for example, an upper surface) of the inductor 100 on which the radiation pattern 130 is located compared to a case (C) in which the extending portion 134 extending from the radiation pattern 130 and connected to the third electrode 132 is formed in a straight line.

Like the above, the inverted input signal having a phase opposite to that of the input signal applied to the first electrode 122 of the inductor 100 is applied to the third electrode 132.

Here, although an example in which the first electrode 122 and the second electrode 124 connected to the coil 120, and the third electrode 132 connected to the radiation pattern 130 are located on the same plane is shown, the first electrode 122, the second electrode 124, and the third electrode 132 can be located on different planes, and the positions and directions thereof can vary according to the structure of the inductor 100.

The magnetic body 110 can have a three-dimensional shape such as a cylindrical shape, a prismatic shape, or the like, and the prismatic shape is shown here as an example.

The radiation pattern 130 can be formed to have an area smaller than a cross-sectional area of the outer surface of the magnetic body 110 to be located in the outer surface of the magnetic body 110 on which the radiation pattern 130 is located.

Like the above, when the radiation pattern 130 to which the signal having a phase opposite to that of the input signal is applied is integrally formed with the inductor 100, the electromagnetic interference generated by the inductor 100 can be effectively offset while minimizing the size of the inductor 100.

Meanwhile, in the inductor 100 according to embodiments of the present disclosure, an inverting circuit can be formed in the magnetic body 110 to apply the inverted input signal to the radiation pattern 130.

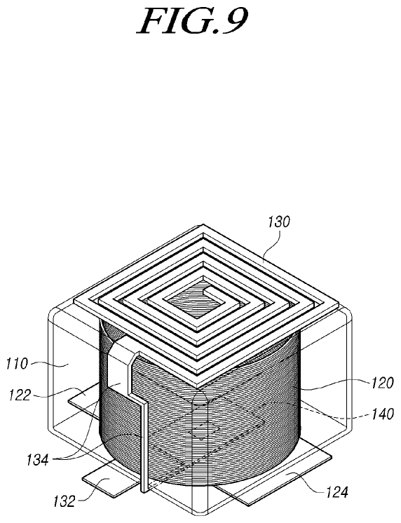

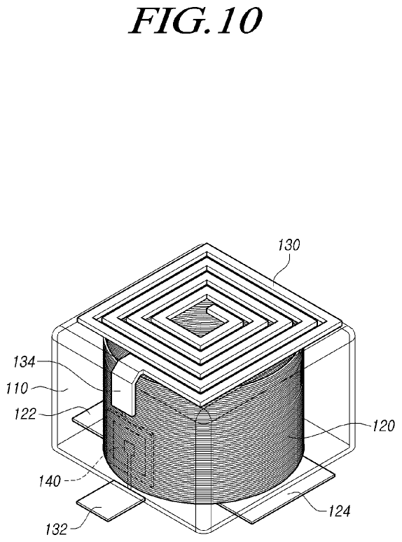

FIGS. 9 and 10 are perspective views illustrating a case in which an inverting circuit is disposed in the inductor according to embodiments of the present disclosure.

Referring to FIGS. 9 and 10, an inductor 100 according to one or more embodiments of the present disclosure includes a magnetic body 110, a coil 120 buried in the magnetic body 110, a radiation pattern 130 formed at an outer side of the magnetic body 110, and an inverting circuit 140 which applies an inverted input signal to the radiation pattern 130.

One side of the coil 120 is electrically connected to a first electrode 122 formed at one side of the magnetic body 110, and the other side of the coil 120 is electrically connected to a second electrode 124 formed at the other side of the magnetic body 110.

The first electrode 122 can be an electrode to which an input signal is applied, and the second electrode 124 can be an electrode to which an output signal is transmitted.

The radiation pattern 130 can be formed on one side surface, for example, an upper surface of the magnetic body 110.

An extending portion 134 extending from the radiation pattern 130 can be disposed in a straight line or a spiral shape along a side surface of the magnetic body 110, and can be connected to the inverting circuit 140 in the magnetic body 110.

Further, the inverting circuit 140 can receive the same input signal as the first electrode 122 through a third electrode 132, and the inverted input signal inverted through the inverting circuit 140 can be supplied to the radiation pattern 130 through the extending portion 134.

At this time, the inverting circuit 140 can be electrically connected to the first electrode 122 to receive the input signal, and the third electrode 132 may not be separately formed on an outer portion of the magnetic body 110. In this case, a portion where the inverting circuit 140 and the first electrode 122 are connected can be referred to as the third electrode 132.

The inverting circuit 140 can be located on a lower surface in the magnetic body 110 or on the side surface of the magnetic body 110 on which the extending portion 134 of the radiation pattern 130 is located.

FIG. 9 is a view illustrating a case in which the inverting circuit 140 is located on the lower surface in the magnetic body 110, and FIG. 10 is a view illustrating a case in which the inverting circuit 140 is located on the side surface of the magnetic body 110 on which the extending portion 134 of the radiation pattern 130 is located. However, the inverting circuit 140 can be buried in the magnetic body 110 regardless of the position.

Here, although an example in which the first electrode 122 and the second electrode 124 connected to the coil 120, and the third electrode 132 connected to the inverting circuit 140 are located on the same plane is shown, the first electrode 122, the second electrode 124, and the third electrode 132 can be located on different planes, and the positions and directions thereof can vary according to the structure of the inductor 100.

The magnetic body 110 can have a three-dimensional shape such as a cylindrical shape, a prismatic shape, or the like, and the prismatic shape is shown here as an example.

The coil 120 can include a winding region to be wound and regions extending from the winding region and electrically connected to the first electrode 122 and the second electrode 124.

In this case, the regions extending from the winding region of the coil 120 can be connected to the first electrode 122 and the second electrode 124 in a state of being buried in the magnetic body 110.

The radiation pattern 130 can receive an inverted input signal having a phase inverted from that of the input signal through the inverting circuit 140 to generate a phase-inverted signal which offsets the electromagnetic interference formed around the inductor 100.

The radiation pattern 130 can have a circular or quadrangular spiral structure, and can be integrally formed on an outer surface of the magnetic body 110.

The radiation pattern 130 can be formed to have an area smaller than a cross-sectional area of the outer surface of the magnetic body 110 to be located in the outer surface of the magnetic body 110 on which the radiation pattern 130 is located.

For example, when the radiation pattern 130 is located on an upper surface of the magnetic body 110, the area of the radiation pattern 130 is formed in a size that does not deviate from the upper area of the magnetic body 110, and thus the radiation pattern 130 can be disposed within the upper area of the magnetic body 110.

Like the above, when the inverting circuit 140 is formed in the magnetic body 110, and the radiation pattern 130 is integrally formed with the inductor 100, the electromagnetic interference generated by the inductor 100 can be effectively offset while minimizing the size of the inductor 100.

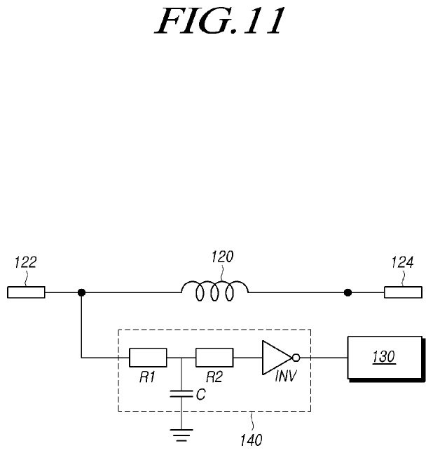

FIG. 11 is a circuit diagram illustrating a case in which an inverting circuit for generating an inverted input signal is included in the inductor according to one of the embodiments of the present disclosure.

Referring to FIG. 11, an inductor 100 according to one of the embodiments of the present disclosure includes a magnetic body 110, a coil 120 buried in the magnetic body 110, a radiation pattern 130 formed at an outer side of the magnetic body 110, and an inverting circuit 140 which applies the inverted input signal to the radiation pattern 130.

The coil 120 receives an input signal through a first electrode 122, and transmits an output signal through a second electrode 124.

The inverting circuit 140 is located between the first electrode 122 and the radiation pattern 130, and transmits an inverted input signal having a phase opposite to that of the input signal applied to the first electrode 122 to the radiation pattern 130.

The inverting circuit 140 can be formed of a first resistor R1 and a second resistor R2 connected in series to the first electrode 122, an inverter INV connected to the second resistor R2, and a capacitor C connected between a contact point between the first resistor R1 and the second resistor R2 and the ground.

The inverted input signal having a phase opposite to that of the input signal applied to the first electrode 122 is transmitted to the radiation pattern 130 by the inverting circuit 140 having such a configuration, and the electromagnetic interference signal formed around the inductor 100 can be offset by the phase-inverted signal generated by the radiation pattern 130.

In this case, since the inverting circuit 140 supplies the inverted input signal having a phase opposite to that of the input signal applied to the first electrode 122 to the radiation pattern 130, an output terminal of the inverting circuit 140 can be connected to an extending portion 134 of the radiation pattern 130.

Like the above, the inductor 100 in which the inverting circuit 140 is disposed is effective when the printed circuit board 150 constituting the electronic device does not have a separate inverting circuit 140.

However, the electronic device can include or may not include the inverting circuit 140 according to the purpose or configuration thereof.

Accordingly, the inductor 100 of the present disclosure includes a control circuit which controls the operation of the inverting circuit 140 in addition to the inverting circuit 140, and thus can generate the phase-inverted signal and reduce the electromagnetic interference through the radiation pattern 130 regardless of whether the inverting circuit is present on the printed circuit board 150 (e.g., see FIG. 4).

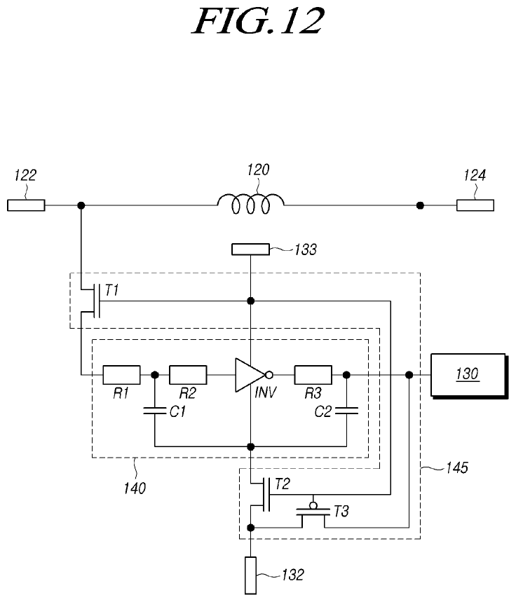

FIG. 12 is a circuit diagram illustrating an example in which an inverting circuit and a control circuit are located in the inductor according to one of the embodiments of the present disclosure.

Referring to FIG. 12, an inductor 100 according to one of the embodiments of the present disclosure includes a magnetic body 110, a coil 120 buried in the magnetic body 110, a radiation pattern 130 formed at an outer side of the magnetic body 110, an inverting circuit 140 which applies an inverted input signal to the radiation pattern 130, and a control circuit 145 which controls the operation of the inverting circuit 140.

The coil 120 receives an input signal through a first electrode 122, and transmits an output signal through a second electrode 124.

The inverting circuit 140 is located between the first electrode 122 and the radiation pattern 130, and transmits an inverted input signal having a phase opposite to that of the inputsignal applied to the first electrode 122 to the radiation patern 130.

The inverting circuit 140 can include a first resistor R1 and a seond resistor R2 connected in series to the first electrode 122, an inverter INV connected to the second resistor R2, and a first capacitor C1 connected to a contact point between the first resistor R1 and the second resistor R2. Further, the inverting circuit 140 can further include a third resistor R3 connected to an output terminal of the inverter INV and a second capacitor C2 connected between the third resistor R3 and the radiation pattern 130.

The control circuit 145 can include a first transistor T1 having a drain node connected to the first electrode 122, a source node connected to the first resistor R1 of the inverting circuit 140, and a gate node connected to a fourth electrode 133.

The first transistor T1 can be formed as an N-type transistor, and thus turned on to transmit the input signal input through the first electrode 122 to the inverting circuit 140 when a high-level driving voltage (i.e., a second driving voltage capable of turning on the first transistor) is applied to the fourth electrode 133.

Further, the control circuit 145 can include a second transistor T2 having a drain node and a gate node connected to the fourth electrode 133, and a source node connected to the third electrode 132.

The second transistor T2 can be formed as an N-type transistor, and thus turned on to cause a current by the driving voltage applied to the fourth electrode 133 to flow to the third electrode 132 when the high-level driving voltage is applied to the fourth electrode 133.

Further, the control circuit 145 can include a third transistor T3 having a drain node connected to the radiation pattern 130, a source node connected to the third electrode 132, and a gate node connected to the fourth electrode 133.

The third transistor T3 can be formed as a P-type transistor, and thus turned on to transmit a signal applied to the third electrode 132 to the radiation pattern 130 when a low-level driving voltage (i.e., a first driving voltage capable of turning on the third transistor) is applied to the fourth electrode 133.

The fourth electrode 133 is an electrode from which a driving voltage is applied to the control circuit 145, and can be located in the inductor 100 or on an outer surface of the inductor 100. Further, the fourth electrode 133, the first electrode 122, the second electrode 124, and the third electrode 132 can be located on the same plane or on different planes.

In this configuration, when the inverting circuit 140 operates, the inverted input signal having a phase opposite to that of the input signal applied through the first electrode 122 can be generated by the inverting circuit 140 and transmitted to the radiation pattern 130.

On the other hand, when the inverted input signal having a phase opposite to that of the input signal of the first electrode 122 is input to the third electrode 132, the inverting circuit 140 is blocked, and the inverted input signal can be transmitted to the radiation pattern 130 by the turned-on third transistor T3.

As a result, the inductor 100 of the present disclosure can generate the phase-inverted signal and reduce the electromagnetic interference through the radiation pattern 130 regardless of whether the inverting circuit is present on the printed circuit board 150.

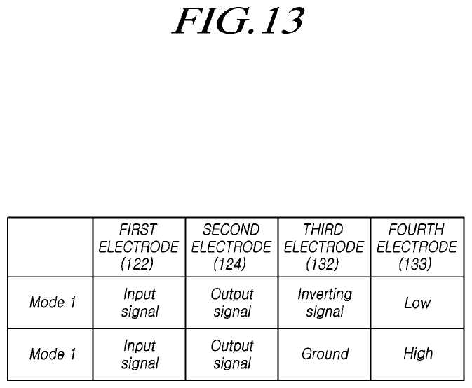

FIG. 13 is a diagram illustrating operations of the first to fourth electrodes according to a case in which a non-inverted input signal and an inverted input signal are input to the third electrode in the inductor according to one of the embodiments of the present disclosure.

Referring to FIG. 13, in the inductor 100 according to one of the embodiments of the present disclosure, an input signal is applied to the first electrode 122, and the second electrode 124 generates an output signal through the coil 120 regardless of an operation mode.

In this case, in a first mode (Mode 1) in which the inverted input signal (Inverting signal) having a phase opposite to that of the input signal of the first electrode 122 is input through the third electrode 132, the operation of the inverting circuit 140 is blocked by the fourth electrode 133 to which the low-level driving voltage is applied. Further, the inverted input signal (Inverting signal) input through the third electrode 132 can be transmitted to the radiation pattern 130 through the third transistor T3.

On the other hand, in a second mode (Mode 2) in which the input signal (non-inverting signal) having a phase the same as that of the input signal of the first electrode 122 is input through the third electrode 132, the third electrode 132 is switched to the ground. Further, since the inverting circuit 140 is operated by the fourth electrode 133 to which the high-level driving voltage is applied, the inverted input signal (Inverting signal) can be transmitted to the radiation pattern 130.

As a result, the inductor 100 of the present disclosure can generate the phase-inverted signal and reduce the electromagnetic interference through the radiation pattern 130 regardless of whether the inverting circuit is present on the printed circuit board 150.

The above-described embodiments of the present disclosure will be briefly described as follows.

An inductor 100 according to embodiments of the present disclosure can include a magnetic body 110, a coil 120 buried in the magnetic body 110, a first electrode 122 formed on a first portion of the magnetic body 110 and electrically connected to one end of the coil 120, a second electrode 124 formed on a second portion of the magnetic body 110 and electrically connected to the other end of the coil 120, a radiation pattern 130 formed on a first surface of the magnetic body 110, and a third electrode 132 formed on a third portion of the magnetic body 110 and electrically connected to the radiation pattern 130.

The magnetic body 110 can be formed in a cylindrical shape or prismatic shape.

The magnetic body 110 can include powder of a metal alloy having soft magnetic properties.

The magnetic body 110 can be formed so that the coil 120 and the radiation pattern 130 are integrated by a poly binder including magnetic powder and a resin.

The radiation pattern 130 can be formed in a circular or quadrangular spiral structure.

The radiation pattern 130 can have an area smaller than a cross-sectional area of an outer surface of the magnetic body 110.

The radiation pattern 130 can be coated on an upper portion of a paste applied to an outer side of the magnetic body 110.

The first surface can be an upper surface of the magnetic body 110, and can be electrically connected to the third electrode 132 through an extending portion 134 disposed along a second surface of the magnetic body 110.

The second surface can be a side surface of the magnetic body 110, and the extending portion 134 can be formed in a spiral structure surrounding the second surface.

The first electrode 122, the second electrode 124, and the third electrode 132 can be located on the same plane.

The inductor 100 according to embodiments of the present disclosure can further include an inverting circuit 140 configured to output a second input signal to the third electrode 132, wherein a phase of the second input signal is opposite to a phase of a first input signal applied to the first electrode 122.

The inverting circuit 140 can be located on a lower surface in the magnetic body 110 or on the side surface of the magnetic body 110.

The inverting circuit 140 can include a first resistor and a second resistor connected in series to the first electrode, an inverter connected to the second resistor, and a capacitor connected between a contact point between the first resistor and the second resistor and the ground.

The inductor 100 according to embodiments of the present disclosure can further include a control circuit 145 which controls the operation of the inverting circuit 140.

The control circuit 145 can include a first transistor having a drain node connected to the first electrode 122, a source node connected to the first resistor of the inverting circuit 140, and a gate node connected to a fourth electrode 133, a second transistor having a drain node and a gate node connected to the fourth electrode 133, and a source node connected to the third electrode 132, and a third transistor having a drain node connected to the radiation pattern 130, a source node connected to the third electrode 132, and a gate node connected to the fourth electrode 133.

The first transistor and the second transistor can be N-type transistors, and the third transistor can be a P-type transistor.

In a first mode in which the second input signal having a phase opposite to a phase of the first input signal of the first electrode 122 is applied to the third electrode 132, a low-level driving voltage can be applied to the fourth electrode 133.

In a second mode in which a third input signal having a phase the same as a phase of the first input signal of the first electrode 122 is applied to the third electrode 132, the third electrode 132 can be electrically connected to the ground, and a high-level driving voltage can be applied to the fourth electrode 133.

An electronic device according to embodiments of the present disclosure can include an inductor 100 in which a radiation pattern 130 is formed on a surface of a magnetic body 110, a printed circuit board 150 on which the inductor 100 is disposed, and an inverting circuit 152 which is formed on the printed circuit board 150, inverts a phase of an input signal applied to the inductor 100 to generate an inverted input signal, and supplies the inverted input signal to the radiation pattern 130 of the inductor 100.

The inductor 100 can include a coil 120 buried in the magnetic body 110, a first electrode 122 formed on a first portion of the magnetic body 110 and electrically connected to one end of the coil 120, a second electrode 124 formed on a second portion of the magnetic body 110 and electrically connected to the other end of the coil 120, and a third electrode 132 formed on a third portion of the magnetic body 110 to transmit the inverted input signal supplied from the inverting circuit 152 to the radiation pattern 130.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein can be applied to other embodiments and applications without departing from the spirit and scope of the present invention. The above description and the accompanying drawings provide an example of the technical idea of the present invention for illustrative purposes only. For example, the disclosed embodiments are intended to illustrate the scope of the technical idea of the present invention. Thus, the scope of the present invention is not limited to the embodiments shown, but is to be accorded the widest scope consistent with the claims. The scope of protection of the present invention should be construed based on the following claims, and all technical ideas within the scope of equivalents thereof should be construed as being included within the scope of the present invention.

What is claimed is:

1. An inductor comprising:
a magnetic body;
a coil located in the magnetic body;
a first electrode located on a first portion of the magnetic body, and electrically connected to one end of the coil;
a second electrode located on a second portion of the magnetic body, and electrically connected to another end of the coil;
a radiation pattern located on a first surface of the magnetic body; and
a third electrode located on a third portion of the magnetic body, and electrically connected to the radiation pattern.

2. The inductor of claim 1, wherein the magnetic body has a cylindrical shape or a prismatic shape.

3. The inductor of claim 1, wherein the magnetic body includes powder of a metal alloy having soft magnetic properties.

4. The inductor of claim 1, wherein the magnetic body is formed so that the coil and the radiation pattern are integrated by a poly binder including magnetic powder and a resin.

5. The inductor of claim 1, wherein the radiation pattern has a circular or quadrangular spiral structure.

6. The inductor of claim 1, wherein the radiation pattern has an area smaller than a cross-sectional area of an outer side surface of the magnetic body.

7. The inductor of claim 1, wherein the radiation pattern is coated on an upper portion of a paste applied to an outer side of the magnetic body.

8. The inductor of claim 1, wherein the first surface of the magnetic body is an upper surface of the magnetic body, and is electrically connected to the third electrode through an extending portion disposed along a second surface of the magnetic body.

9. The inductor of claim 8, wherein the second surface of the magnetic body is a side surface of the magnetic body, and
the extending portion has a spiral structure surrounding the second surface.

10. The inductor of claim 1, wherein the first electrode, the second electrode, and the third electrode are located on a same plane.

11. The inductor of claim 1, further comprising an inverting circuit configured to output a second input signal to the third electrode,
wherein a phase of the second input signal is opposite to a phase of a first input signal applied to the first electrode.

12. The inductor of claim 11, wherein the inverting circuit is located on a lower surface in the magnetic body or a side surface of the magnetic body.

13. The inductor of claim 11, wherein the inverting circuit includes:
a first resistor and a second resistor connected in series to the first electrode;
an inverter connected to the second resistor; and
a capacitor connected between the ground and a contact point between the first resistor and the second resistor.

14. The inductor of claim 11, further comprising a control circuit configured to control an operation of the inverting circuit.

15. The inductor of claim 14, wherein the control circuit includes:
a first transistor having a drain node connected to the first electrode, a source node connected to a first resistor of the inverting circuit, and a gate node connected to a fourth electrode;
a second transistor having a drain node and a gate node connected to the fourth electrode, and a source node connected to the third electrode; and
a third transistor having a drain node connected to the radiation pattern, a source node connected to the third electrode, and a gate node connected to the fourth electrode.

16. The inductor of claim 15, wherein the first transistor and the second transistor are N-type transistors, and
the third transistor is a P-type transistor.

17. The inductor of claim 15, wherein, in a first mode in which the second input signal having a phase opposite to a phase of the first input signal of the first electrode is applied to the third electrode, a first driving voltage capable of turning on the third transistor is applied to the fourth electrode.

18. The inductor of claim 15, wherein, in a second mode in which a third input signal having a phase the same as a phase of the first input signal of the first electrode is applied to the third electrode,
the third electrode is electrically connected to the ground, and
a second driving voltage capable of turning on the first transistor is applied to the fourth electrode.

19. An electronic device comprising:
an inductor including a radiation pattern disposed on a surface of a magnetic body;
a printed circuit board on which the inductor is disposed; and
an inverting circuit disposed on the printed circuit board, configured to invert a phase of an input signal applied to the inductor to generate an inverted input signal, and configured to supply the inverted input signal to the radiation pattern of the inductor.

20. The electronic device of claim 19, wherein the inductor includes:
a coil located in the magnetic body;
a first electrode located on a first portion of the magnetic body, and electrically connected to one end of the coil;
a second electrode located on a second portion of the magnetic body, and electrically connected to another end of the coil; and
a third electrode located on a third portion of the magnetic body, and configured to transmit the inverted input signal supplied from the inverting circuit to the radiation pattern.
